(19) United States
(12) Patent Application Publication
(10) Pub. No.: US 2011/0184802 A1
(43) Pub. Date: Jul. 28, 2011

(54) AUCTION FORMAT SELECTION USING HISTORICAL DATA

(75) Inventors: Samuel Ieong, Mountain View, CA (US); Jinsong Tan, Bethlehem, PA (US)

(73) Assignee: MICROSOFT CORPORATION, Redmond, WA (US)

(21) Appl. No.: 12/692,659

(22) Filed: Jan. 25, 2010

(51) Int. Cl. G06Q 30/00; G06Q 10/00; G06N 5/02

(52) U.S. Cl. 705/14.45; 705/14.46; 705/14.71; 706/52; 705/26.3

(57) ABSTRACT

An auction format may be selected pursuant to analyzing and identifying certain statistical patterns in historical data. For example, the choice of auction format may be based on whether bids and quality exhibit correlation, which can be identified in the historical data. By identifying the statistical patterns in the data, one can choose an auction format that can achieve generation of higher revenue. Such techniques allow an auctioneer, such as a search engine, to generate higher revenue than using a fixed auction format. For example, in the context of sponsored search auction, if the value of a click and the probability of a click are positively correlated, the auctioneer generates higher revenue by ranking the advertisers by bids rather than by bids multiplied by quality.

### BACKGROUND

As the Internet has grown, online advertising has become a popular method by which advertisers may reach consumers. For example, search engines sell ad slots on search engines to advertisers. These advertisements are typically much more targeted than print-media or TV advertising because the user performing the search indicates a current interest via a query consisting of a few keywords. The search engine may target an ad based on the user's current interest usually expressed by the keywords in the query and sometimes the history of keywords issued by the user. A similar phenomenon occurs in other online advertising, where the user conveys her intent by visiting a page or a sequence of pages related to a particular subject. For example, a user entering the query “digital camera” in the search box of a search engine, or a user reading a webpage consisting of reviews for digital cameras, is likely to be interested in digital cameras, and hence is more receptive to advertisements for digital cameras than a person flipping through the pages of the newspaper. Thus, a retailer selling digital cameras would like to bid for the query term “digital camera” so that the retailer's ad is shown for this query.

The number of advertisements that the search engine can show to a user is limited, and different positions or slots on the search results page are more desirable for advertisers. Hence, search engines typically use an auction system for allocating the slots to advertisers. Advertisers bid on keywords they predict their target market will use as search terms when they are looking for a product or service. When a user types a keyword query matching the advertiser's keyword list, or views a page with relevant content, the advertiser's advertisement may be shown. These advertisements are called a “sponsored link” or “sponsored ads” and appear next to or above the natural results on search engine results pages, or anywhere a webmaster chooses on a content page.

Thus, auctions are often used for allocating scarce resources. The party that allocates the scarce resources is known as the auctioneer, and the participants to the auctions are known as bidders. Auction formats play a role in determining how much revenue an auctioneer makes from the auction. For example, the amount of revenue a search engine receives from sponsored search depends on how advertisers are ranked, and when and how much the advertisers are charged. Advertisers are conventionally ranked by bid multiplied by quality, as approximated by the click-through rates of the advertisers.

### SUMMARY

An auction format may be selected pursuant to analyzing and identifying certain statistical patterns in historical data. By identifying the statistical patterns in the data, one can choose an auction format that can achieve generation of higher revenue. Such techniques allow an auctioneer, such as a search engine, to generate higher revenue than using a fixed auction format.

In an implementation, the choice of auction format may be based on whether bids and quality exhibit correlation, which can be identified in the historical data. The historical data may comprise historical logged bids and click-through rates to the advertisers.

In an implementation, for auctions where the item to be auctioned off has an uncertain value, if the value of the item is positively correlated with the probability of the item having value, the bidders of the auctions are ranked by their bids, rather than by bids times the corresponding probability.

In an implementation, in the context of sponsored search auction, if the value of a click and the probability of a click are positively correlated, the auctioneer generates higher revenue by ranking the advertisers by bids rather than by bids multiplied by quality.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an example online environment;

FIG. 2 is a block diagram of an implementation of an example auction subsystem;

FIG. 3 is an operational flow of an implementation of a method of selecting an auction format using historical data;

FIG. 4 is an operational flow of an implementation of a method of analyzing historical data for use in selecting an auction format; and

FIG. 5 shows an exemplary computing environment.

### DETAILED DESCRIPTION

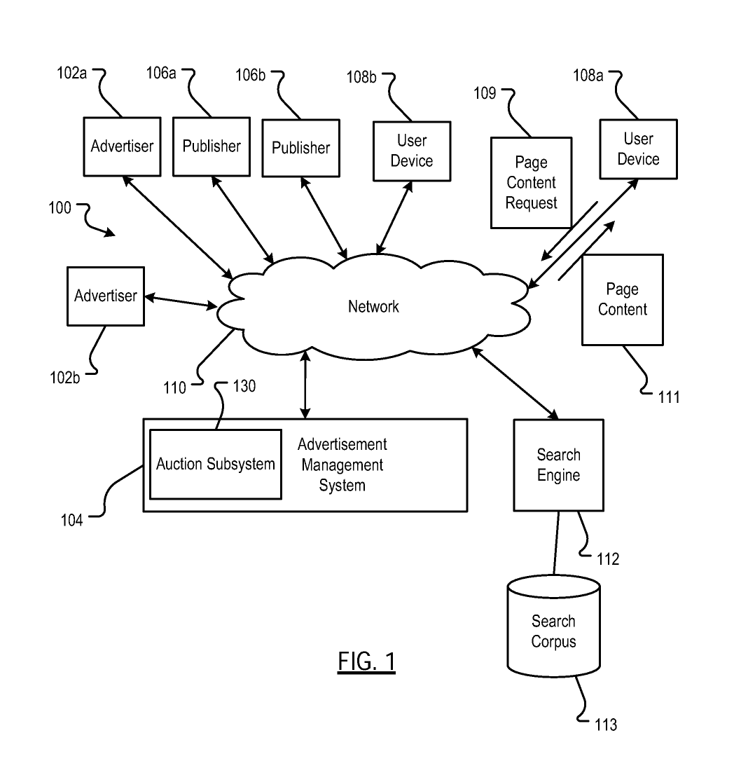

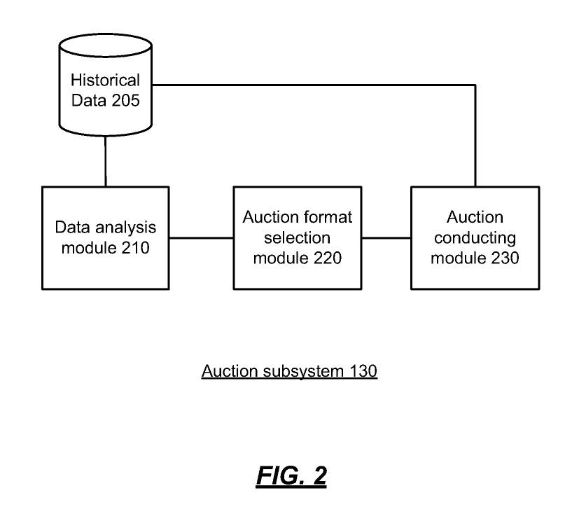

FIG. 1 is a block diagram of an example online environment 100. The online environment 100 may facilitate selection of an auction format using historical data, such as the historical data 205 of FIG. 2. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (106a and 106b), and two user devices (108a and 108b) are shown, the online environment 100 may include many thousands of advertisers, publishers, and user devices. Implementations described herein are suitable for use with the Internet, which refers to a specific global internetwork of networks. However, it should be understood that other networks can be used instead of or in addition to the Internet, such as an intranet, an extranet, a virtual private network (VPN), a non-TCP/IP based network, any LAN or WAN or the like.

In some implementations, one or more advertisers 102a and/or 102b may directly or indirectly enter, maintain, and/or track advertisement information in the advertisement management system 104. The advertisements may be in the form of graphical advertisements, such as banner advertisements, text only advertisements, image advertisements, audio advertisements, video advertisements, advertisements combining one of more of any of such components, etc., or any other type of electronic advertisement document.

A user device, such as user device 108a, may submit a page content request 109 to a publisher or the search engine 112. In some implementations, the page content 111 may be provided to the user device 108a in response to the request 109. The page content 111 may include advertisements provided by the advertisement management system 104. Example user devices 108 include personal computers (PCs), mobile communication devices, television set-top boxes, etc. In some implementations, the user devices 108 may include a desktop personal computer, workstation, laptop, PDA, cell phone, or any WAP-enabled device or any other computing device capable of interfacing directly or indirectly with the network 110. A user device may run an HTTP client, e.g., a browsing program, such as MICROSOFT INTERNET EXPLORER or other browser, or a WAP-enabled browser in the case of a cell phone, PDA or other wireless device, or the like, allowing a user of a user device to access, process, and view information and pages available to it from the advertisers, publishers, search engines, etc.

Advertisements may also be provided from the publishers 106. For example, one or more publishers 106a and/or 106b may submit advertisement requests for one or more advertisements to the advertisement management system 104. The advertisement management system 104 responds by sending the advertisements to the requesting publisher 106a or 106b for placement on one or more of the publisher's web properties (e.g., websites and other network-distributed content).

Advertisements may also be provided through the use of the search engine 112. The search engine 112 may receive queries for search results. In response, the search engine 112 may retrieve relevant search results from an index of documents (e.g., from an index of web pages). Search results may include, for example, lists of web page titles, snippets of text extracted from those web pages, and hypertext links to those web pages, and may be grouped into a predetermined number of (e.g., ten, twenty, etc.) search results. According to an implementation, the search engine 112 is configured to provide search result data, advertisements, and media content to a user device, and the advertisers and publishers are configured to provide data and media content such as web pages to the user device, for example, in response to links selected in search result pages provided by the search engine 112. The search engine 112 may reference various collection technologies for collecting information from the World Wide Web and for populating one or more indexes with, for example, pages, links to pages, etc. Such collection technologies include automatic web crawlers, spiders, etc., as well as manual or semi-automatic classification algorithms and interfaces for classifying and ranking web pages within a hierarchical structure.

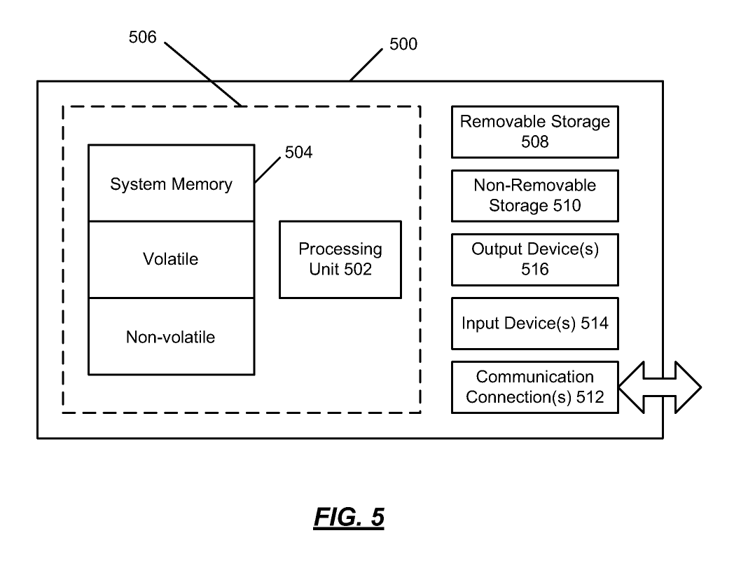

The search engine 112 may include at least one server and an associated database system, and may include multiple servers and associated database systems, and although shown as a single block, may be geographically distributed. An example search engine may comprise, or be comprised within, a computing environment such as that described with respect to FIG. 5.

The search engine 112 may submit a request for advertisements to the advertisement management system 104. The request may include a number of advertisements desired. This number may depend on the search results, the amount of screen or page space occupied by the search results, the size and shape of the advertisements, etc. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers), scores related to the search results (e.g., information retrieval scores), snippets of text extracted from identified documents (e.g., web pages), full text of identified documents, feature vectors of identified documents, etc.

According to an implementation, the search engine 112 may include algorithms that provide search results and advertisements to users in response to the search query received from a user device 108. The search query may be transmitted to the search engine 112 to initiate an Internet search (e.g., a web search). The search engine 112 locates content matching the search query from a search corpus 113. The search corpus 113 represents content that is accessible via the World Wide Web, the Internet, intranets, local networks, and wide area networks.

The search engine 112 may retrieve content from the search corpus 113 that matches the search query and may transmit the matching content (i.e., search results) to the user device in the form of a web page to be displayed in a user interface module of the user device. In some implementations, the most relevant search results are displayed to a user in the user interface module. The search engine 112 may also provide advertisements to the user device 108 in response to the search query.

The search engine 112 may combine the search results with one or more of the advertisements provided by the advertisement management system 104. This combined information may then be forwarded to the user device 108 that requested the content as the page content 111. The search results may be maintained as distinct from the advertisements, so as not to confuse the user between paid advertisements and presumably neutral search results.

In some implementations, the advertisement management system 104 may also be configured to have an advertisement engine that gathers, maintains, and displays ranked advertisements, a click data engine that gathers and maintains click-through rates and click data, and a payment engine that charges advertisers based on clicks or other criteria. An example advertisement management system may comprise, or be comprised within, a computing environment such as that described with respect to FIG. 5.

The advertisers 102, user devices 108, and/or the search engine 112 may also provide usage information to the advertisement management system 104. This usage information may include measured or observed user behavior related to advertisements that have been served, such as, for example, whether or not a conversion or a selection related to an advertisement has occurred. Such usage information may be stored as historical data in a storage device, memory, or other storage by the advertisement management system 104, as described further herein.

In addition to the advertisements being selected based on content such as a search query or web page content of a publisher, the advertisements may also be selected using an auction. The advertisement management system 104 may include an auction subsystem 130. The advertisers 102 may be permitted to select or bid an amount the advertisers are willing to pay for placement of an advertisement on content that is provided to the user device, such as the amount they are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of advertisement based on a keyword. In some implementations, the auction subsystem 130 may determine the position that each bid will occupy based on the results. The auction subsystem 130 may select the top k bids to occupy the bid positions, where k is, for example, the number of advertisement positions available on a webpage. Thus, ads may be placed based on the bid amounts and/or other information, as described further herein.

The format of an auction may be defined by an interaction protocol (e.g., how the bidders interact with the auctioneer), an allocation rule (e.g., based on the information the bidder provided, who gets what), and a payment rule (e.g., based on the information provided, how much each bidder pays). In sponsored search auctions (e.g., for a particular keyword), the search engine is the auctioneer, and websites that are interested in showing their advertisements are the bidders. The scarce resource to be allocated is the space alongside search results, referred to as slots. The resource is scarce because there are more bidders than slots, and slots that appear higher in the search results are more valuable. Thus, there may be n bidders and k slots, with n>k. Each bidder submits a value for how much he is willing to pay for each click he receives. This value may depend on the keywords the users issue to the search engine. The value submitted by bidder i may be denoted bᵢ.

Pay-per-click, also known as paid search, is an advertising model used on search engines, advertising networks, and content websites in which advertisers only pay when a user clicks on an advertisement to visit the advertiser's website. Thus, in pay-per-click, the payment rule is restricted to bidders only paying when users click on their advertisements. With this style of payment rule (e.g., known as pay-per-click rules), bidders whose advertisements are not shown do not pay anything, and bidders whose advertisements are shown but not clicked also do not pay anything. Because of this restriction, a factor that the auctioneer may consider is how frequently an advertisement is clicked. This frequency is known as the click-through rate. The click-through rate of bidder i assigned to slot j may be denoted by α_{i,j}. It is commonly assumed that the click-through rate depends on a bidder-dependent quality, qᵢ, and a slot-dependent bias, rⱼ, and that the click-through rate satisfies the relationship α_{i,j}=qᵢrⱼ.

Given the constraints noted above, the choice of auction format may thus be based on an allocation rule (e.g., which bidders get which slots on the page) and a payment rule (e.g., how much bidder i in slot j pays when her advertisement is clicked). Many different auction formats may be used, such as “bid-based allocation, first-price payment”, “bid-based allocation, second-price payment”, and “bid-times-quality allocation, second-price payment”, for example. Although these auction formats are described herein, it is contemplated that other auction formats may also be used and considered when selecting an auction format using the techniques herein.

In bid-based allocation, first-price payment, allocation is performed by ordering the bidders in decreasing order of bids, bᵢ. The first slot is assigned to the highest bidder, the second slot is assigned to the second highest bidder, etc., until slots run out. Regarding payment, the bidder pays how much they bid per click.

In bid-based allocation, second-price payment, allocation is performed the same as described above with respect to bid-based allocation, first-price payment. With respect to payment, however, the bidder pays how much the next bidder bids. For example, if the highest bidder bids $1.50, and the second highest bidder bids $1.25, then the highest bidder pays $1.25 per click. The bidder that gets assigned the k-th slot (i.e., the last slot) pays the bid of the next highest bidder, albeit that bidder does not end up being allocated any slot.

In bid-times-quality allocation, second-price payment, allocation is performed by ordering the bidders in decreasing order of bids multiplied by the quality, bᵢqᵢ. The first slot is assigned to the bidder with the highest multiplication product, the second slot is assigned to the bidder with the second highest product, etc., until slots run out. For payment, the bidder pays the minimum amount needed to maintain her position. For example, if the bidder with the highest product has b₁=$1.00 and q₁=0.25, and the bidder with the second highest product has b₂=$1.50 and q₂=0.1, then the bidder with the highest product pays b₂(q₂/q₁)=$1.50*0.1/0.25=$0.90.

Note that a bidder will not have to pay more than her bid. Even though the next highest bidder in the order may have a higher bid, scaling by the relative quality (q₂/q₁) ensures that a bidder will pay no more than her bid per click.

To compare revenues from different auction formats, consider how much revenue the auction brings in expectation when the bids submitted by the bidders are in equilibrium. Here, the expectation should be taken over the click-through rate and the distribution from which the bidders' valuation are drawn. To simplify, take the bidders' valuation as fixed, and hence the bidders' bids as fixed as well.

Consider the bid-based allocation, second-price payment format. Without loss of generality, suppose the bids submitted are b₁≧b₂≧ . . . ≧bₙ, and that the quality of the bidders are q₁, q₂, . . . , qₙ (not necessarily ordered). The allocation rule allocates the first slot should be assigned to bidder 1, the second slot should be assigned to bidder 2, etc., up until the k-th slot being assigned to bidder k. Recall that r₁, r₂, . . . , rₖ are the slot dependent bias, and that the click-through rate of the i-th bidder assigned to the j-th slot is α_{i,j}=qᵢrⱼ. The expected revenue will then be Rev₁=q₁r₁b₂+q₂r₂b₃+ . . . +qₖrₖbₖ₊₁.

Consider the bid-times-quality allocation, second-price payment format. Without loss of generality, suppose bidder 1 has the largest product b₁q₁, bidder 2 has the second largest product b₂q₂, etc. The allocation rule allocates the first slot to bidder 1, the second slot to bidder 2, etc. The expected revenue will then be Rev₂=q₁r₁b₂ (q₂/q₁)+q₂r₂b₃ (q₃/q₂)+ . . . +qₖrₖbₖ₊₁(qₖ₊₁/qₖ)=q₂r₁b₂+q₃r₂b₃+ . . . +qₖ₊₁rₖbₖ₊₁.

Statistical patterns may be used to determine which auction format to use in a particular situation in order to increase the revenue for the auctioneer. In an implementation, such pattern may be the positive correlation between bids and quality of the bidders. Correlation among two sets of variables attempt to measure how related these variables are. Positive correlation between two sets of variables can be informally interpreted as if the value of one of the variable increases, the other variable also increases.

The variables {b₁, b₂, . . . , bₙ} and {q₁, q₂, . . . , qₙ} are said to be perfectly positively correlated if qᵢ=βbᵢ for bidders i for some common scaling factor β. When the variables satisfy these relationships, the bid-based allocation, second-price payment format yields higher revenue. Note that when the variables are perfectly positively correlated, the allocation rule allocates in exactly the same manner, because for any two bidders i and j, bᵢ≧bⱼ implies bᵢqᵢ≧bⱼqⱼ and vice versa.

Consider the revenues of the two formats:

Rev₁=q₁r₁b₂+q₂r₂b₃+ . . . +qₖrₖbₖ₊₁=βb₁r₁b₂+βb₂r₂b₃+ . . . +βbₖrₖbₖ₊₁

≧βb₂r₁b₂+βb₂r₂b₃+ . . . +βbₖrₖbₖ₊₁=q₂r₁b₂+q₃r₂b₃+ . . . +qₖ₊₁rₖbₖ₊₁=Rev₂.

In general, revenue under the bid-based allocation, second-price payment format will be higher than that under the bid-times-quality allocation, second-price payment not only when the bids are perfectly positively correlated with quality, but also when they satisfy a more general condition where for all bidders i and j, bᵢ≧bⱼ if and only if qᵢ≧qⱼ.

The auctions may be repeated, and hence over time the advertisement management system 104, and thus the auctioneer, may collect data (e.g., additional historical data) about the relationship of the bids and the quality of the bidders. Through use of statistical techniques, such as regression and correlation estimation, an auctioneer may determine a relationship among the bids and the quality of the bidders. As an example, if the auctioneer determines that there is positive correlation between bids and quality, he may decide to use the bid-based allocation, second-price payment format, and when such relationship does not exist, he may use the default bid-times-quality allocation, second-price payment format. As more data is collected, the auctioneer may be able to find more profitable auction formats by making use of the historical data.

FIG. 2 is a block diagram of an implementation of an example auction subsystem, such as the auction subsystem 130 of FIG. 1. The auction subsystem 130 may comprise storage comprising historical data 205, and may further comprise a data analysis module 210, an auction format selection module 220, and an auction conducting module 230.

As noted above, an auction format may be determined using the historical data 205 which may comprise historical auction data, such as historical logged bids and click-through rates to the advertisers. It is common for a search market to provide conversion tracking to advertisers. This allows advertisers to receive detailed statistics of how the clicks that they are paying for in a pay-per-click market convert into profit. When an advertiser opts in to conversion tracking, an auction engine or market for example can calculate the advertiser's conversion rate as it does their click-through rate. Conversions are advertiser-specified and can range from the user visiting a certain web page to actually buying a product from the advertiser. Such information may be stored and comprised within the historical data 205, in an implementation.

The data analysis module 210 may access the storage comprising the historical data 205, may obtain the historical data 205 regarding the item (e.g., an advertisement for placement), and may analyze the historical data 205 to determine whether bids and quality exhibit correlation, in an implementation. The determined information regarding correlation may be provided from the data analysis module 210 to the auction format selection module 220. The auction format selection module 220 may select an auction format, from a plurality of auction formats, which will increase or perhaps maximize the revenue that the auctioneer will obtain from a subsequent auction for the item.

Thus, the auction format may be selected pursuant to analyzing and identifying certain statistical patterns in historical data. In an implementation, the choice of auction format is based on whether bids and quality exhibit correlation, which can be identified in the historical data. By identifying the statistical patterns in the data, one can choose an auction format that can achieve generation of higher revenue. At some point, the auction conducting module 230 may conduct the auction using the selected auction format. Subsequently, the auction format for future auctions may be chosen and perhaps adapted to a different format as additional historical data is made available from auctions that are conducted.

Such techniques allow an auctioneer, for example, a search engine, to generate higher revenue than using a fixed auction format. For example, in the context of sponsored search auction, if the value of a click and the probability of a click are positively correlated, the auctioneer generates strictly higher revenue by ranking the advertisers by bids rather than by bids multiplied by quality. Thus, when the private valuations of the participants (e.g., the advertisers) are correlated one can generate more revenue by choosing a different auction format.

If the probability of success is positively correlated with the bids of the advertisers (also referred to as bidders), the auctioneer can generate higher revenue by ranking the advertiser by bids rather than by the product of bids and success rates. The same is true for auctions in which there is uncertainty in the value of the item being auctioned. For example, consider sponsored search auctions conducted by search engines that are run alongside keyword search. In these auctions, the search engine is auctioning off impressions, which are rights to click. What advertisers are interested in, however, is not just in having their advertisement being displayed, but rather in receiving clicks on their advertisement from the users (and more generally, in the users buying something from their websites). In this context, the value of the impression is either worth zero, if the users do not click on the ads, or some positive amount corresponding to the expected value of a click.

It has been conventionally believed that it is better to rank the ads according to their bids multiplied by quality, as approximated by the click-through rates of the ads, and that the advertisers pay the next higher bid when their ads are clicked. However, this is not optimal when one wants to generate higher revenue from the auction. If the expected value of a click and the click-through rate is positively correlated, one receives higher revenue if the advertisers are ranked only by their bid.

For example, suppose there are two advertisers, Advertiser 1 (having a bid per click of 10 and a click-through rate of 0.2) and Advertiser 2 (having a bid per click of 5 and a click-through rate of 0.1). In this situation, if the ranking is performed by bid times quality, then Advertiser 1 would win, and the expected revenue of the search engine equals the click-through rate of Advertiser 1 * payment per click of Advertiser 1=0.2*(5*0.1/0.2)=0.5, where the payment per click is defined as the bid of the losing advertiser times the click-through rate of the losing advertiser divided by the click-through rate of the winner. However, if the ranking is by bid, then Advertiser 1 would win, and the expected revenue of the search engine equals click-through rate of Advertiser 1 * payment per click of Advertiser 1=0.2*5=1.0, where the payment per click is defined as the bid of the losing advertiser. This calculation demonstrates that the search engine may receive higher revenue under circumstances by ranking by bid.

Thus, the opportunities for ranking by bid to outperform ranking by bid times quality can be determined by analyzing and identifying statistical patterns in the historical data, specifically in an implementation by looking at the historical click-through rates of the advertisers, and their willingness to pay for clicks. If these two quantities are positively correlated, then one should rank the advertisers by bids rather than bids times quality. More generally, the choice of auction format can be guided by historical data.

Note that in the context of web search, the above is not limited to applications directed to sponsored search auctions. For example, an application may be in the area where advertisers are charged per transaction, i.e., only when transactions take place. In such situations, the value per transaction may be positively correlated with the probability of transactions.

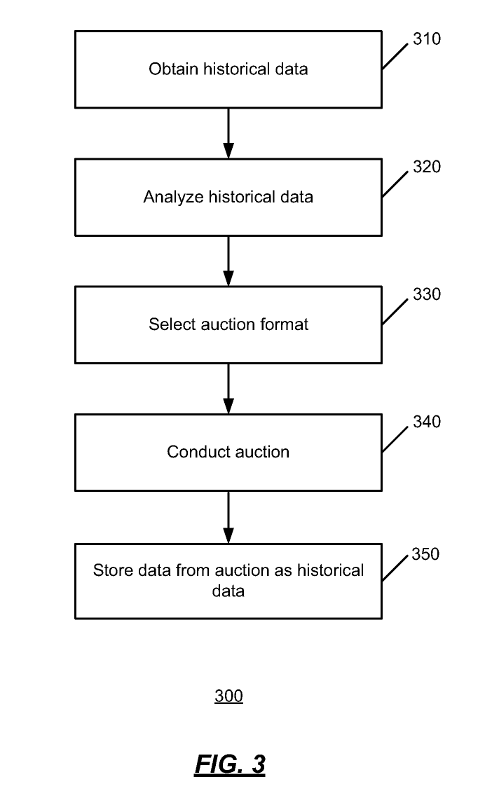

FIG. 3 is an operational flow of an implementation of a method 300 of selecting an auction format using historical data. The method 300 may be performed using the advertisement management system 104 of FIG. 1, for example.

At 310, historical data, such as the historical data 205, is obtained. The historical data 205 may be retrieved by the data analysis module 210 from storage associated with the auction subsystem 130, in an implementation. At 320, the historical data may be analyzed by the data analysis module 210. The data may be analyzed to determine if patterns or a correlation exists between the item to be auctioned, the bidders, the quality of the bidders, the value of the item, click-through rates, etc.

Using the analysis of the historical data, an auction format is selected at 330 for an auction for the item. The auction format is selected from multiple possible auction formats. The selected auction format is the auction format that will increase or maximize the revenue to the auctioneer in an auction for the item. In an implementation, positive correlations determined among the historical data may be used in the selection of an auction format.

At 340, the auction is conducted (e.g., with advertisers bidding on slots) using the auction format that was selected at 330. Data from the auction (e.g., auction results) may be stored as additional historical data at 350, for use in subsequent auction format selections. Also, feedback from the advertisers, revenue from the auction, subsequent results from the placement of the advertisements, etc. may be collected and stored as additional historical data.

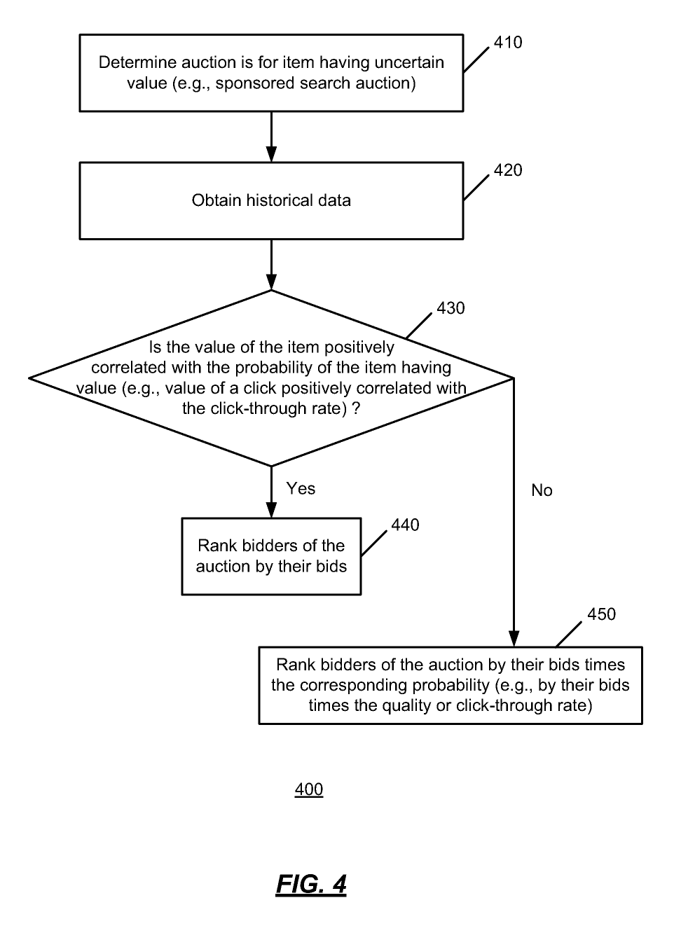

FIG. 4 is an operational flow of an implementation of a method 400 of analyzing historical data for use in selecting an auction format. The method 400 may be performed using the advertisement management system 104 of FIG. 1, for example.

At 410, it may be determined whether an auction is for an item having an uncertain value. Such an auction is a sponsored search auction, for example. Here, the advertiser (also referred to as the merchant) pays the search engine only when a user clicks through and buys something. This is considered to be an uncertain value because the search engine can only show the advertisement, but neither the advertiser nor the search engine knows beforehand whether a user will click on the advertisement.

For an auction of an item having an uncertain value, historical data may be obtained at 420. Similar to 310, the historical data may be retrieved by the data analysis module 210 from storage associated with the auction subsystem 130, in an implementation.

The data may be analyzed for patterns that will make it more favorable to use one type of auction over another type of auction in terms of generating revenue for the auctioneer. In an implementation, at 430, it may be determined by analyzing the historical data whether the value of the item is positively correlated with the probability of the item having value. For example, in the context of a sponsored search auction, it may be determined using the historical data whether the value of a click is positively correlated with the click-through rate.

In an implementation, if an advertiser has a high conversion rate (user click-through rate) and a high value of conversion (a user buys a high value item pursuant to the user clicking through), that is considered to be a positive correlation.

For auctions where the item to be auctioned off has an uncertain value, if the value of the item is positively correlated with the probability of the item having value, the bidders of the auctions may be ranked by their bids, at 440 (i.e., the auction is run using bids only). Otherwise, at 450, if there is no positive correlation, then the bidders are ranked by their bids times the corresponding probability, such that the auction is run using bids multiplied by the probability (e.g., where the corresponding probability is the click-through rate).

Thus, in an implementation, for a sponsored search auction, if the value of a click is positively correlated with the click-through rates, then the advertisers are ranked by their bids, rather than by their bids multiplied by their quality, where quality is the click-through rate.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
obtaining historical data at a computing device from a storage device, wherein the historical data comprises data pertaining to auctions;
analyzing the historical data, by a data analysis module of the computing device, to obtain an analysis of the historical data; and
selecting an auction format, using the analysis of the historical data by an auction format selection module of the computing device, for an item to be auctioned in an auction.

2. The method of claim 1, further comprising conducting the auction of the item using the selected auction format, by an auction conducting module of the computing device.

3. The method of claim 2, further comprising obtaining data pertaining to the auction and storing the data in the storage device with the historical data for use in future auction format selection.

4. The method of claim 1, wherein analyzing the historical data comprises determining whether bids and quality exhibit correlation.

5. The method of claim 1, wherein the item being auctioned has an uncertain value, wherein analyzing the historical data comprises determining if the value of the item is positively correlated with the probability of the item having value, and wherein selecting the auction format comprises ranking bidders of the auction by bids if the value of the item is positively correlated with the probability of the item having value and otherwise ranking bidders by bids multiplied by the probability.

6. The method of claim 1, wherein the auction is a sponsored search auction and the historical data comprises historical logged bids and click-through rates to advertisers.

7. The method of claim 6, wherein selecting the auction format comprises selecting one of a plurality of auction formats, wherein the plurality of auction formats comprises a bid-based allocation, first-price payment auction format, a bid-based allocation, second-price payment auction format, and a bid-times-quality allocation, second-price payment auction format.

8. The method of claim 6, wherein analyzing the historical data comprises determining if the value of a click and the probability of a click are positively correlated, and wherein selecting the auction format comprises ranking the advertisers by bids if the value of a click and the probability of the click are positively correlated and otherwise ranking the advertisers by the bids multiplied by the probability.

9. The method of claim 1, wherein selecting the auction format comprises selecting the auction format from a plurality of auction formats, wherein the selected auction format increases revenue from the auction as compared with the other auction formats of the plurality of auction formats.

10. A method comprising:
obtaining historical data for auctions directed to an item having an uncertain value, by a computing device from a storage device;
analyzing the historical data, by a data analysis module of the computing device, to determine if the value of the item is correlated with the probability of the item having value; and
selecting an auction format for the item to be auctioned in an auction, using information regarding whether the value of the item is correlated with the probability of the item having value, by an auction format selection module of the computing device.

11. The method of claim 10, wherein analyzing the historical data comprises determining if the value of the item is positively correlated with the probability of the item having value.

12. The method of claim 11, wherein if the value of the item is positively correlated with the probability of the item having value, then the selected auction format comprises ranking bidders of the auction by the bids, and otherwise the selected auction format comprises ranking bidders of the auction by the bids multiplied by the probability.

13. The method of claim 10, wherein the auction is a sponsored search auction and the historical data comprises historical logged bids and click-through rates to advertisers.

14. The method of claim 13, wherein selecting the auction format comprises selecting one of a plurality of auction formats, wherein the plurality of auction formats comprises a bid-based allocation, first-price payment auction format, a bid-based allocation, second-price payment auction format, and a bid-times-quality allocation, second-price payment auction format.

15. The method of claim 13, wherein analyzing the historical data comprises determining if the value of a click is positively correlated with the click-through rate, and if so, then the selected auction format comprises ranking bidders of the auction by the bids, and otherwise the selected auction format comprises ranking bidders of the auction by the bids multiplied by the click-through rate.

16. A system comprising:
at least one computing device that:
receives historical data pertaining to auctions; and
stores the historical data in a storage device;
a data analysis module that analyzes the historical data to obtain an analysis of the historical data; and
an auction format selection module that selects an auction format from a plurality of auction formats, using the analysis of the historical data, for an item to be auctioned in an auction.

17. The system of claim 16, further comprising an auction conducting module that conducts the auction of the item using the selected auction format, wherein the at least one computing device obtains data pertaining to the auction and stores the data in the storage device with the historical data for use in future auction format selection.

18. The system of claim 16, wherein the data analysis module determines, from the historical data, whether bids and quality exhibit correlation.

19. The system of claim 16, wherein the item being auctioned has an uncertain value, wherein analyzing the historical data comprises determining if the value of the item is positively correlated with the probability of the item having value, and wherein selecting the auction format comprises ranking bidders of the auction by bids if the value of the item is positively correlated with the probability of the item having value and otherwise ranking bidders by bids multiplied by the probability.

20. The system of claim 16, wherein the auction is a sponsored search auction and the historical data comprises historical logged bids and click-through rates to advertisers, and wherein analyzing the historical data comprises determining if the value of a click and the probability of the click are positively correlated, and wherein the plurality of auction formats comprises a bid-based allocation, first-price payment auction format, a bid-based allocation, second-price payment auction format, and a bid-times-quality allocation, second-price payment auction format.
